(19) United States
(12) Patent Application Publication
(10) Pub. No.: US 2019/0300233 A1
(43) Pub. Date: Oct. 3, 2019

(54) BOX WITH SEALABLE DISPENSER SYSTEM

(71) Applicant: Mike Ormonde, Mississauga (CA)

(72) Inventor: Mike Ormonde, Mississauga (CA)

(21) Appl. No.: 15/939,853

(22) Filed: Mar. 29, 2018

(51) Int. Cl. B65D 5/74; A23L 7/135

(52) U.S. Cl. CPC B65D 5/744; A23V 2002/00; A23L 7/135

(57) ABSTRACT

A box with sealable dispenser system including a carton having a plurality of side walls, a dispenser including a sealing member, and a pour spout. The dispenser is configured on one of the plurality of side walls. The pour spout is configured to pivot between an open-position and closed-position and the sealing member is configured to temporarily seal the dispenser in the closed-position. The pour spout may dispense items such as cereal stored within the carton when in the open-position. The sealing member creates an insect-resistant seal and prevent items stored within from losing freshness.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of containers and more specifically relates to containers having spouts.

### 2. Description of Related Art

Many types of boxes, particularly card-board boxes and especially boxes of the type containing cereal, soap and so forth, are provided with means of forming an opening in the side of the box near the top so that the contents of the box may be poured out. Usually such boxes are rectangular in cross section and have a punched outline of an opening near the top in one of the narrow sides. The user, in order to discharge the contents of the box, by thumb pressure or the like, pushes out the opening which forces a hinged tab to the interior of the box forming an opening so that the contents may be discharged from the box by tilting the box in the direction of the opening. While this type of means of providing an opening in a box is completely satisfactory in many respects, one of the difficulties is that after the openings is punched out there is no means of subsequently sealing the box. The contents of a box exposed to free air circulation deteriorate faster. Having open boxes on hand is especially serious when such types of boxes are used for cereal or other edible contents. Typically, a cereal box, as utilized by most families, is opened when first used and may be kept in a kitchen cabinet for several weeks before the total contents are utilized. During this time the box, being open, is exposed to infestation by a variety of insects, and even rodents.

U.S. Pat. No. 7,984,844 to Edward W. Jones relates to a carton with spout. The described carton with spout includes a carton for holding a dispensable material. The carton has a dispenser panel including a spout for dispensing the material. An outer spout panel overlaps the spout in the dispenser panel and is at least partially detachable from the dispenser panel to facilitate opening the spout.

### BRIEF SUMMARY OF THE INVENTION

In view of the foregoing disadvantages inherent in the known containers art, the present disclosure provides a novel box with sealable dispenser system. The general purpose of the present disclosure, which will be described subsequently in greater detail, is to provide a resealable box for preserving contents and effectively eliminating spills.

A box with sealable dispenser system is disclosed herein. The box with sealable dispenser system includes a carton having a plurality of side walls, a dispenser including a sealing member, and a pour spout. The plurality of side walls defines the carton. The dispenser is configured on one of the plurality of side walls. The dispenser includes the pour spout and the sealing member. The pour spout is configured to pivot between an open-position and closed-position (suitable for sealing). The sealing member is positioned at a lip of the dispenser. The sealing member is a temporary seal with adhesive configured to be sealed and un-sealed. The sealing member is configured to create an insect-resistant seal and prevent items stored within from losing freshness. The pour spout is configured to dispense items stored within the carton when in the open-position.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a box with sealable dispenser system, constructed and operative according to the teachings of the present disclosure.

FIG. 1 is a perspective view of the box with sealable dispenser system during an ‘in-use’ condition, according to an embodiment of the disclosure.

FIG. 2 is a perspective view of the box with sealable dispenser system of FIG. 1, according to an embodiment of the present disclosure.

FIG. 3 is a perspective view of the box with sealable dispenser system of FIG. 1, according to an embodiment of the present disclosure.

FIG. 4 is a perspective view of the box with sealable dispenser system of FIG. 1, according to an embodiment of the present disclosure.

FIG. 5 is a perspective view of the box with sealable dispenser system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to containers and more particularly to a box with sealable dispenser system as used to improve the packaging of food items in cartons.

Generally, box with sealable dispenser system is a container/box with a side opening. The box may be used for keeping cereal fresh and keep out insects. Instead of opening a traditional cereal box on top, the box with sealable dispenser system will open on the side. The opening is resealable and includes an adhesive for temporarily sealing the opening to prevent insects and other unwanted items from entering a cereal box. Cereal may come in a bag within the container. For those options, the bag may be glued around the opening.

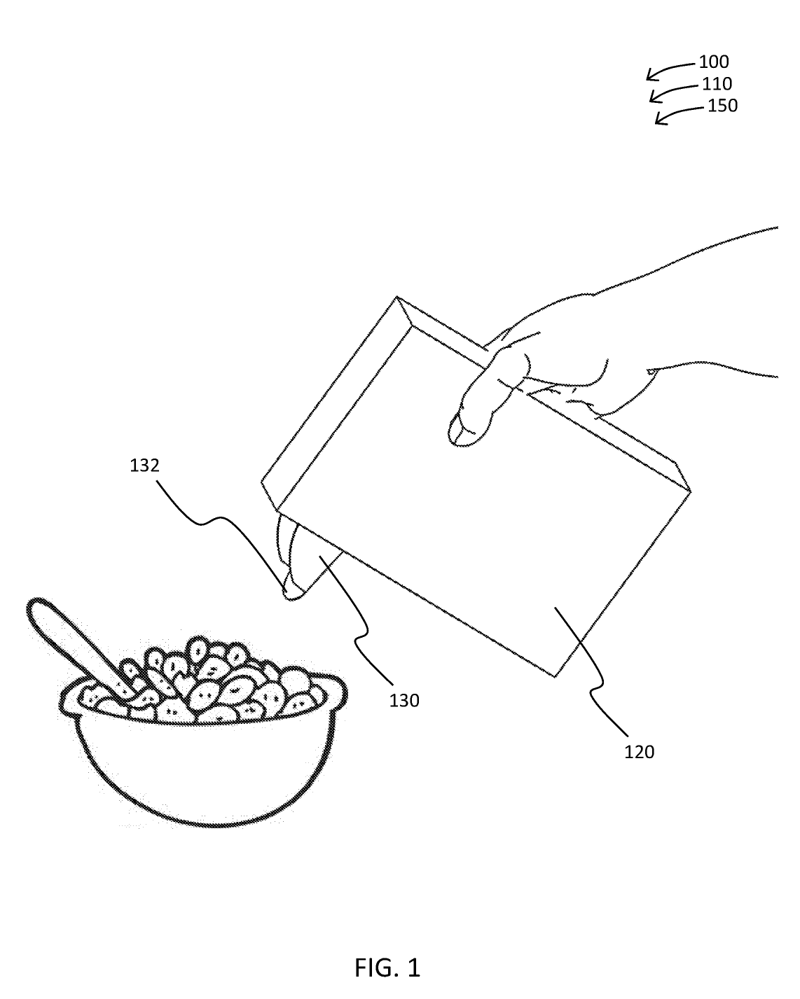

Referring now more specifically to the drawings by numerals of reference, there is shown in FIGS. 1-5, various views of a box with sealable dispenser system 100. FIG. 1 shows a box with sealable dispenser system 100 during an ‘in-use’ condition 150, according to an embodiment of the present disclosure. As illustrated, the box with sealable dispenser system 100 may include a carton 110 having a plurality of side walls 120, a dispenser 130 including a sealing member 132, and a pour spout 136. The box with sealable dispenser system 100 provides a sealed carton 110 for storing items within and protecting items from outside contaminants.

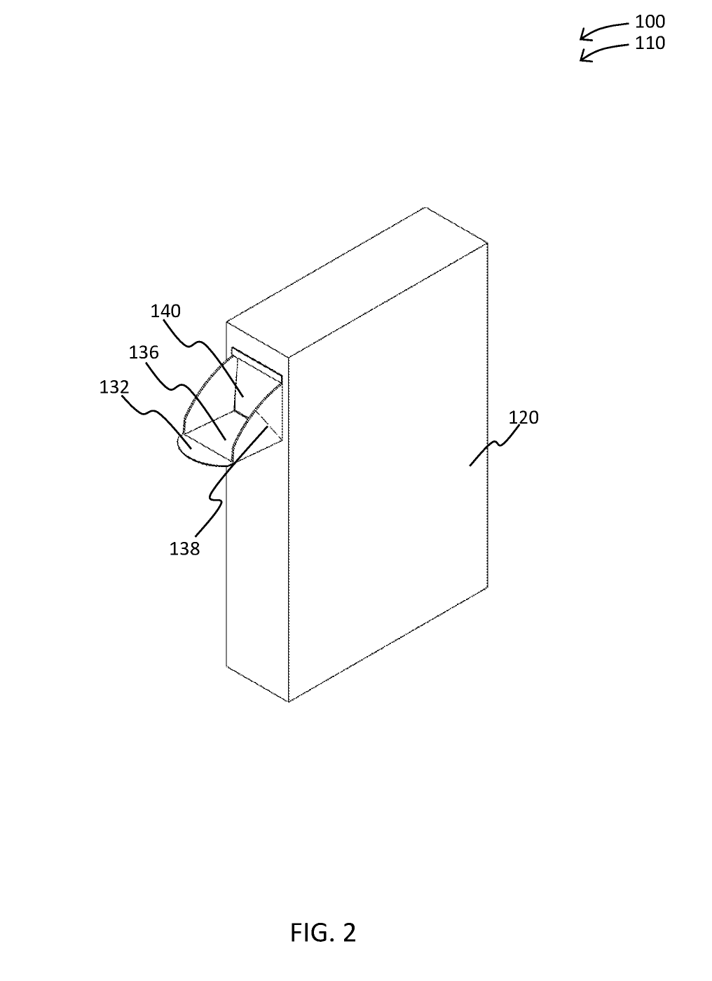

FIG. 2 shows a perspective view of the box with sealable dispenser system 100 of FIG. 1, according to an embodiment of the present disclosure. As above, the box with sealable dispenser system 100 may include the carton 110 having the plurality of side walls 120, the dispenser 130 including the sealing member 132, and the pour spout 136. The plurality of side walls 120 define the carton 110. The dispenser 130 is configured on one of the plurality of side walls 120. The dispenser 130 includes the pour spout 136 and the sealing member 132. The pour spout 136 is configured to pivot between an open-position and closed-position; the sealing member 132 is configured to temporarily seal the dispenser 130 in the closed-position. The pour spout 136 is configured to dispense items stored within the carton 110 when in the open-position.

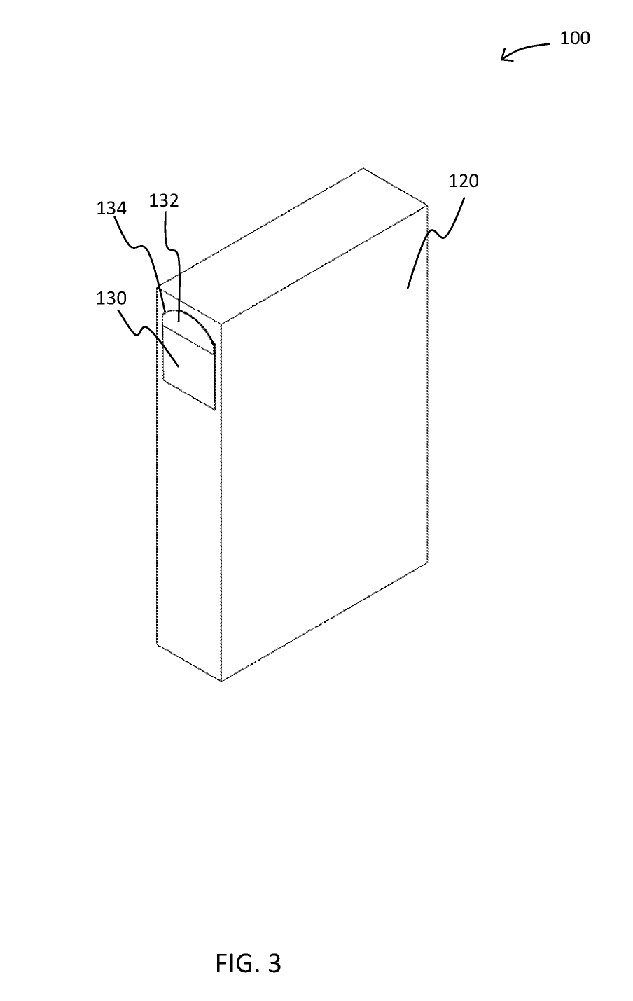

Referring now to FIG. 3 showing a perspective view of the box with sealable dispenser system 100 of FIG. 1, according to an embodiment of the present disclosure. As above, the box with sealable dispenser system 100 may include the carton 110 for keeping contents fresh and sealed within. In a preferred embodiment, the carton 110 is a cereal-carton, the item stored within is cereal. The carton 110 has a three-dimensional rectangular profile. The sealing member 132 is positioned at a lip of the dispenser 130. The sealing member 132 is a temporary seal with adhesive configured to be sealed and un-sealed (repeatedly as needed). The sealing member 132 may include a pull-tab 134 for a user to easily open and close the dispenser 130. The sealing member 132 is configured to create an insect-resistant seal and prevent items stored within from losing freshness.

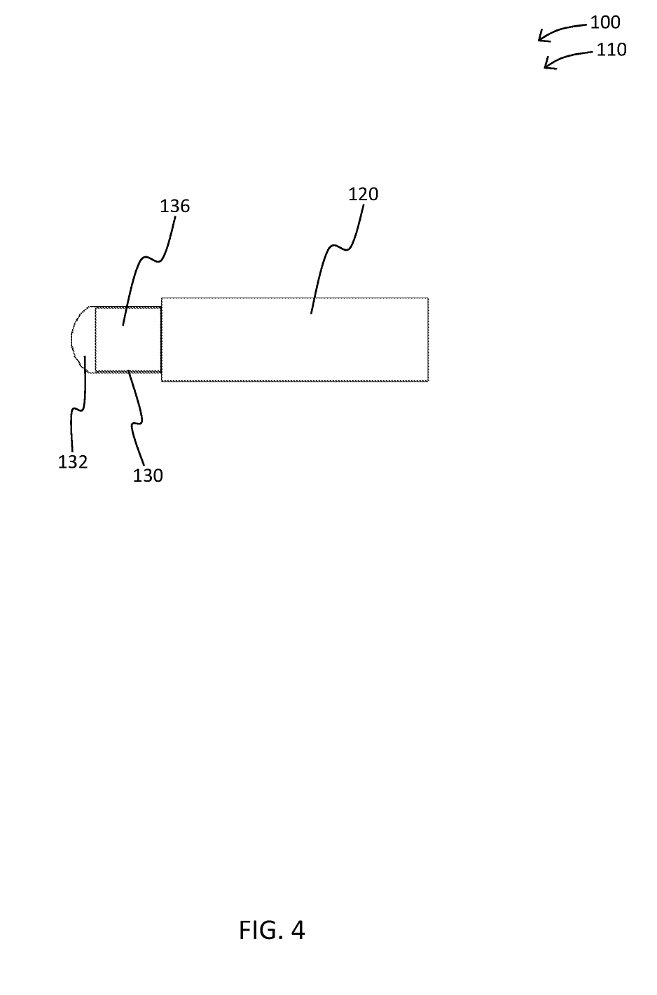

FIG. 4 shows a perspective view of the box with sealable dispenser system 100 of FIG. 1, according to an embodiment of the present disclosure. As above, the box with sealable dispenser system 100 which in a preferred embodiment, the lip of the dispenser 130 is approximately 2.5 inches wide. The dispenser 130 comprises a minimum length of approximately 1.5 inches and a maximum length of approximately 2.5 inches. The dispenser 130 comprises a minimum width of approximately 1.75 inches and a maximum width of approximately 2 inches. The dispenser 130 is approximately 1 inch from a top-portion of the carton 110. The sealing member 132 extends approximately 0.25 inches from the lip.

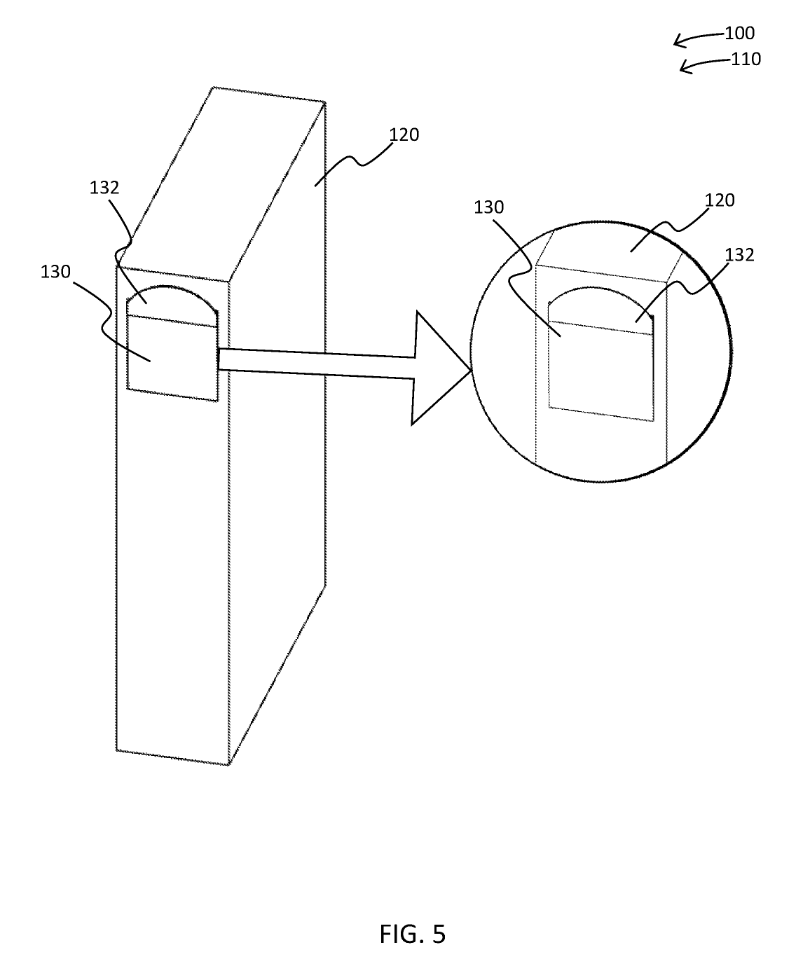

FIG. 5 shows a perspective view of the box with sealable dispenser system 100 of FIG. 1, according to an embodiment of the present disclosure. As above, the box with sealable dispenser system 100 may include the carton 110 having the plurality of side walls 120, the dispenser 130 including the sealing member 132, and the pour spout 136. The pour spout 136 is in communication with an opening 140 in the plurality of side walls 120; the opening 140 is configured to dispense the items stored within the carton 110 when the dispenser 130 is in the open-position. The dispenser 130 further comprises foldable side wings 138 positioned parallel to one another and on opposing sides of the pour spout 136. The side wings define outer walls 138 of the pour spout 136 and fold and unfold as the dispenser 130 is closed and opened. The dispenser 130 is flush with one of the plurality of side walls 120 on which the dispenser 130 is positioned during the closed-position.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A box with sealable dispenser system comprising:
a carton having;
a plurality of side walls;
a dispenser including;
a sealing member; and
a pour spout;
wherein said plurality of side walls define said carton;
wherein said dispenser is configured on one of said plurality of side walls;
wherein said dispenser includes said pour spout and said sealing member;
wherein said pour spout is configured to pivot between an open-position and closed-position, said sealing member configured to temporarily seal said dispenser in said closed-position; and
wherein said pour spout is configured to dispense items stored within said carton when in said open-position.

2. The box with sealable dispenser system of claim 1, wherein said carton has a three-dimensional rectangular profile.

3. The box with sealable dispenser system of claim 1, wherein said sealing member is positioned at a lip of said dispenser.

4. The box with sealable dispenser system of claim 3, wherein said sealing member is a temporary seal configured to be sealed and un-sealed.

5. The box with sealable dispenser system of claim 4, wherein said sealing member includes adhesive.

6. The box with sealable dispenser system of claim 5, wherein said sealing member comprises a pull-tab.

7. The box with sealable dispenser system of claim 1, wherein said sealing member is configured to create a seal.

8. The box with sealable dispenser system of claim 3, wherein said lip of said dispenser is approximately 2.5 inches wide.

9. The box with sealable dispenser system of claim 8, wherein said dispenser comprises a minimum length of approximately 1.5 inches and a maximum length of approximately 2.5 inches.

10. The box with sealable dispenser system of claim 9, wherein said dispenser comprises a minimum width of approximately 1.75 inches and a maximum width of approximately 2 inches.

11. The box with sealable dispenser system of claim 1, wherein said dispenser is approximately 1 inch from a top-portion of said carton.

12. The box with sealable dispenser system of claim 8, wherein said sealing member extends approximately 0.25 inches from said lip.

13. The box with sealable dispenser system of claim 1, wherein said pour spout is in communication with an opening in said plurality of side walls, said opening configured to dispense said items stored within said carton when said dispenser is in said open-position.

14. The box with sealable dispenser system of claim 1, wherein said dispenser further comprises foldable side wings positioned parallel to one another and on opposing sides of said pour spout, said side wings define outer walls of said pour spout.

15. The box with sealable dispenser system of claim 1, wherein said dispenser is flush with one of said plurality of side walls during said closed-position.

16. The box with sealable dispenser system of claim 1, wherein said carton is a cereal-carton, said item stored within is cereal.

17. A box with sealable dispenser system, the box with sealable dispenser system comprising:
a carton having;
a plurality of side walls;
a dispenser including;
a sealing member; and
a pour spout;
wherein said plurality of side walls define said carton;
wherein said carton has a three-dimensional rectangular profile;
wherein said dispenser is configured on one of said plurality of side walls;
wherein said dispenser includes said pour spout and said sealing member;
wherein said pour spout is configured to pivot between an open-position and closed-position, said sealing member configured to temporarily seal said dispenser in said closed-position;
wherein said pour spout is in communication with an opening in said plurality of side walls, said opening configured to dispense said items stored within said carton when said dispenser is in said open-position;
wherein said sealing member is configured to create a seal;
wherein said sealing member is positioned at a lip of said dispenser;
wherein said sealing member is a temporary seal configured to be sealed and un-sealed;
wherein said sealing member includes adhesive;
wherein said sealing member comprises a pull-tab;
wherein said pour spout is configured to dispense items stored within said carton when in said open-position;
wherein said lip of said dispenser is approximately 2.5 inches wide;
wherein said dispenser comprises a minimum length of approximately 1.5 inches and a maximum length of approximately 2.5 inches;
wherein said dispenser comprises a minimum width of approximately 1.75 inches and a maximum width of approximately 2 inches;
wherein said dispenser is approximately 1 inch from a top-portion of said carton;
wherein said sealing member extends approximately 0.25 inches from said lip;
wherein said dispenser further comprises foldable side wings positioned parallel to one another and on opposing sides of said pour spout, said side wings define outer walls of said pour spout;
wherein said dispenser is flush with one of said plurality of side walls during said closed-position; and
wherein said carton is a cereal-carton, said item stored within is cereal.
